(19) United States
(12) Patent Application Publication
(10) Pub. No.: US 2013/0037146 A1
(43) Pub. Date: Feb. 14, 2013

(54) FLUID VALVES HAVING MULTIPLE FLUID FLOW CONTROL MEMBERS

(71) Applicant: Richard James Anagnos, Conrad, IA (US)

(72) Inventor: Richard James Anagnos, Conrad, IA (US)

(21) Appl. No.: 13/554,618

(22) Filed: Jul. 20, 2012

Related U.S. Application Data
(60) Provisional application No. 61/522,336, filed on Aug. 11, 2011.

(51) Int. Cl. G05D 7/03

(52) U.S. Cl. 137/614.16; 137/614.21

(57) ABSTRACT

Fluid valves having multiple fluid flow control members are described herein. An example valve trim apparatus includes a first flow control member disposed in a passageway of a fluid valve, the first flow control member moves relative to a first orifice of the passageway to provide a first fluid flow characteristic through the passageway. A second flow control member is disposed within the passageway and is to move relative to a second orifice of the passageway defined by the first flow control member when the first flow control member is in sealing engagement with the first orifice to provide a second fluid flow characteristic through the passageway. The first fluid flow characteristic is different than the second fluid flow characteristic.

### CROSS-REFERENCE TO RELATED APPLICATION

This patent claims the benefit of U.S. Provisional Patent Application Serial No. 61/522,336, filed on Aug. 11, 2011, entitled “FLUID VALVES HAVING MULTIPLE FLUID FLOW CONTROL MEMBERS,” which is hereby incorporated herein by reference in its entirety.

### FIELD OF THE DISCLOSURE

This patent relates to fluid valves and, more specifically, to fluid valves having multiple fluid flow control members.

### BACKGROUND

Process control systems use a variety of field devices to control process parameters. For example, a fluid valve may be employed to control or modulate fluid flow through a flow passageway. A fluid valve typically includes a valve body defining a fluid flow passageway between an inlet and an outlet of the fluid valve. To control the fluid flow through the passageway, a fluid valve typically employs a flow control member that moves relative to a valve seat that defines an orifice of the passageway. The valve seat and the flow control member are sized to provide a certain fluid flow characteristic or range through the orifice of the passageway. However, in some instances, it may be desirable to provide a fluid flow characteristic (e.g., a fluid flow rate) that is different than (e.g., less than) the fluid flow characteristic provided by the orifice.

### BRIEF DESCRIPTION OF THE DRAWINGS

FIG. 1 depicts a known fluid valve.

FIG. 2 depicts an example fluid valve having an example valve trim apparatus described herein.

FIG. 3 depicts a cross-sectional view of the valve trim apparatus of the example fluid valve of FIG. 2.

FIG. 4 depicts a control valve assembly having the example valve trim apparatus of FIGS. 2 and 3 shown in a closed position.

FIG. 5 depicts the example fluid valve of FIG. 4 in an intermediate position.

FIG. 6 depicts the example fluid valve of FIG. 4 in an open position.

FIG. 7 depicts an example actuator that may be used with an example fluid valve described herein.

### DETAILED DESCRIPTION

The examples described herein relate to fluid valves having multiple fluid flow control members (e.g., valve plugs) or valve trim apparatus. More specifically, the fluid flow control members described herein control fluid flow through multiple orifices of a fluid valve to provide different fluid flow characteristics, capacities and/or ranges through a passageway of the fluid valve. For example, a first flow control member or high flow plug can move relative to a first orifice to provide a first fluid flow characteristic (e.g., a fluid flow rate) through a passageway of the fluid valve and a second flow control member or low flow plug can move relative to a second orifice to provide a second fluid flow characteristic (e.g., a fluid flow rate) through the passageway. For example, the first orifice can provide a relatively high fluid flow condition or capacity and the second orifice can provide a fine, precise or controlled low flow condition or capacity.

In this manner, an example fluid valve described herein can provide relatively high fluid flow through the first orifice without compromising the precision of a relatively low fluid flow capacity through the second orifice. Likewise, the fluid valve described herein can provide precise low fluid flow capacity without compromising the high fluid flow capacity. Thus, the second flow control member and the second orifice provide a reduced trim to provide a relatively low, precisely controlled fluid flow condition or capacity.

The example fluid flow control members described herein may independently control fluid flow through a common fluid flow passageway. To move the first flow control member described herein independently of, and relative to, the second flow control member described herein, the examples described herein may include a first valve trim apparatus slidably coupled relative to a second valve trim apparatus. For example, a first valve trim apparatus described herein may have a first flow control member operatively coupled to a first actuator via a first valve stem and a second valve trim apparatus described herein may have a second flow control member operatively coupled to a second actuator via a second valve stem, where the first valve stem is slidably coupled to the second valve stem.

In particular, at least a portion of the first flow control member and/or the first valve stem may include an aperture to slidably receive at least a portion of the second flow control member and/or the second valve stem such that the second flow control member and/or the second valve stem slides relative to, through or within the first control member and/or the first valve stem, and the first valve stem slides relative to, about or over the second flow control member and/or the second valve stem. In some examples, a first valve stem may provide a sleeve-like structure to slidably receive a second valve stem having a rod-like structure.

In some examples, a first orifice of a passageway may be defined by a valve seat or seat ring disposed in the passageway of the fluid valve and the second orifice may be defined by the first flow control member. For example, the second orifice may be defined by an aperture and/or a pathway in the first flow control member. For example, the second flow control member may be slidably coupled to the first flow control member and can move relative to the pathway of the first flow control member to control the fluid flow across the second orifice when the first flow control member is in engagement (e.g., sealingly engaged) with the first valve seat. Thus, the first flow control member may be positioned relative to the first valve seat to provide a first fluid flow rate through a passageway of a valve that is different from a second fluid flow rate through the passageway provided by the position of the second flow control member relative to the second orifice when the first flow control member is in engagement with the first valve seat.

In yet other examples, the example flow control members described herein may be movable or controlled in stages to control fluid flow through a fluid flow passageway of a valve. For example, a first flow control member may be moved to an open position to equalize and/or reduce a pressure differential across a second flow control member prior to moving the second flow control member to an open position to enable a substantial reduction of breakout force compared to known fluid valves.

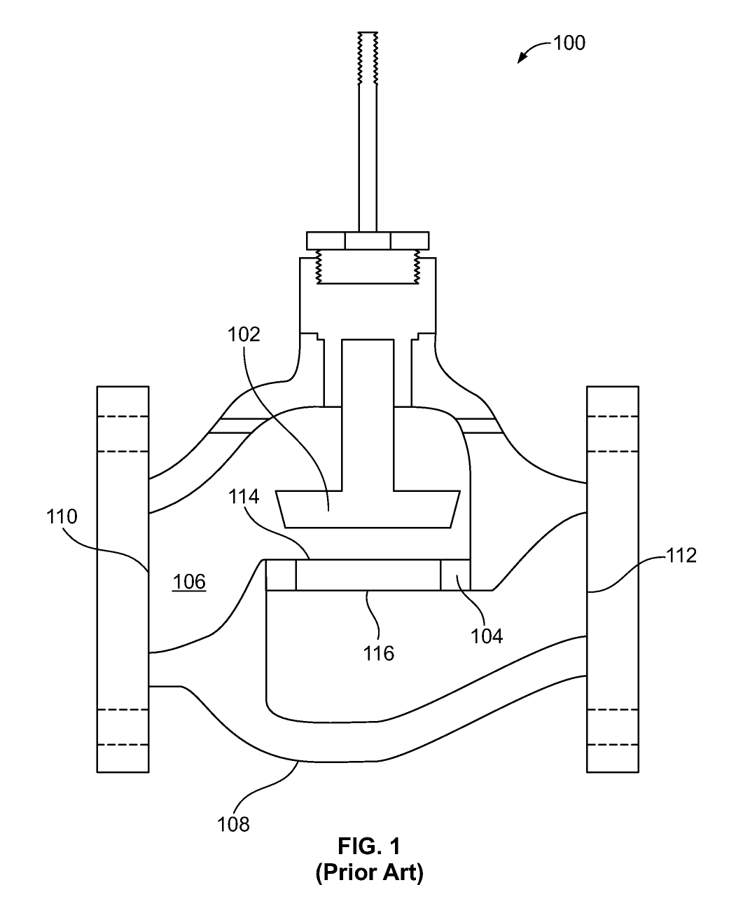

FIG. 1 depicts a known fluid valve 100. The fluid valve 100 of FIG. 1 includes a valve plug 102 that moves relative to a valve seat 104 to control fluid flow through a passageway 106 of a valve body 108 between an inlet 110 and an outlet 112. In operation, an actuator (not shown) moves the valve plug 102 relative to the valve seat 104 between a closed position to restrict fluid flow through the passageway 106 and an open position to allow fluid flow through the passageway 106. The valve seat 104 includes an opening 114 that defines an orifice 116 of the passageway 106. In particular, the valve plug 102 and the valve seat 104 are sized or dimensioned to provide a certain fluid flow characteristic, range or capacity through the passageway 106 of the fluid valve 100. Thus, the fluid valve 100 can only control fluid flow through the passageway 106 to be within a certain fluid flow range or rate based on the size of the orifice 116.

Thus, if the fluid valve 100 is sized to provide relatively low fluid flow rates, the ability of the fluid valve 100 to provide relatively high fluid flow rates is diminished or compromised. Likewise, if the fluid valve 100 is sized to provide relatively high fluid flow rates, the ability of the fluid valve 100 to provide relatively low, precisely controlled fluid flow rates is diminished or compromised. Although not shown, in some examples, a reduced trim assembly (e.g., a smaller sized orifice and/or valve plug) may be coupled to the fluid valve 100 to reduce the flow area (e.g., provide a smaller orifice) through the passageway 106 and provide a lower fluid flow rate or range than is provided by the orifice 116 (e.g., the valve plug 102 and/or valve seat 104). However, the reduced trim reduces the capacity (e.g., a maximum capacity) of the fluid valve 100. Additionally, installation of a reduced trim assembly typically requires a shut-down, which increases costs.

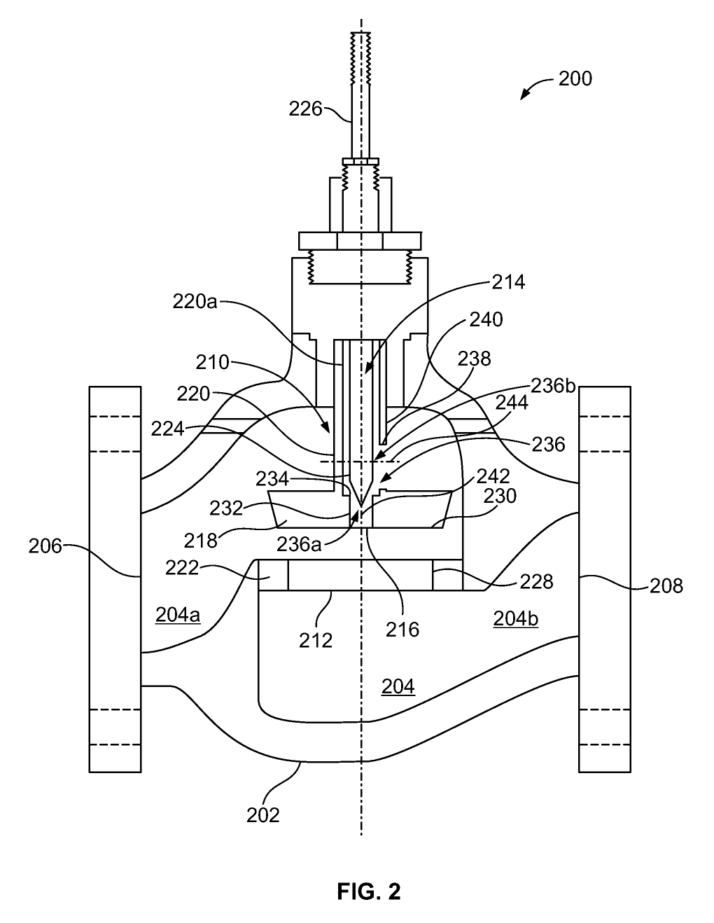

FIG. 2 illustrates an example fluid valve 200 described herein. The fluid valve 200 of FIG. 2 includes a valve body 202 that defines a fluid flow path or passageway 204 between an inlet 206 and an outlet 208. Unlike the fluid valve 100 of FIG. 1, the passageway 204 of the example fluid valve 200 of FIG. 2 includes multiple fluid orifices. In this example, the fluid valve 200 includes a first valve trim apparatus or assembly 210 to control fluid flow through a first orifice 212 of the passageway 204 and a second valve trim apparatus or assembly 214 to control fluid flow through a second orifice 216 of the passageway 204. In particular, the first orifice 212 is to provide a first fluid flow area of the passageway 204 when the first valve trim apparatus 210 moves relative to the first orifice 212. The second orifice 216 is to provide a second fluid flow area of the passageway 204 when the second valve trim apparatus 214 moves relative to the second orifice 216 and the first valve trim apparatus 210 prevents fluid flow through the first orifice 212. For example, the first flow area provided by the first orifice 212 is greater than the second fluid flow area provided by the second orifice 216.

In this example, the first valve trim apparatus 210 is slidably coupled relative to the second valve trim apparatus 214 to enable the first and second valve trim apparatus 210 and 214 to slide relative to each other. Additionally or alternatively, as described in greater detail below, the first valve trim apparatus 210 and the second valve trim apparatus 214 can be moved independently relative to each other.

In the illustrated example of FIG. 2, the first valve trim apparatus 210 includes a first flow control member 218 (e.g. a valve plug), a first or outer valve stem 220 and a first valve seat or seat ring 222. The second valve trim apparatus 214 includes a second flow control member 224 (e.g., a valve plug) and a second or inner valve stem 226. As shown in FIG. 2, the first valve stem 220 has an opening 220a to slidably receive at least a portion of the second flow control member 224 and/or the second valve stem 226. More specifically, the first valve stem 220 is a sleeve-like structure that slidably receives the second valve stem 226, which is a rod-like structure, and the second flow control member 224.

In the illustrated example, the first valve seat 222 is disposed within the passageway 204 and includes an opening 228 to define the first orifice 212 of the passageway 204. The first flow control member 218 has a sealing surface 230 that moves relative to the first valve seat 222 to control or modulate fluid flow through the passageway 204. The first orifice 212 is sized or dimensioned to allow or provide a first fluid flow characteristic, range or capacity through the passageway 204 (e.g., a maximum fluid flow rate).

Additionally, the first flow control member 218 includes an opening 232 adjacent the sealing surface 230 that defines the second orifice 216. In particular, the opening 232 is coaxially aligned with the opening 220a of the first valve stem 220 and provides a second valve seat 234 that defines the second orifice 216 of the passageway 204. The second flow control member 224 moves relative to the second valve seat 234 when the first flow control member 218 is in engagement with the first valve seat 222 to control or modulate fluid flow through the passageway 204 via the second orifice 216. In particular, the second orifice 216 provides a second fluid flow characteristic, range or capacity that is different from the first fluid flow characteristic, range or capacity. For example, the first flow control member 218 moves relative to the first valve seat 222 to provide a relatively high fluid flow rate through the passageway 204 and the second flow control member 224 moves relative to the second valve seat 234 when the first flow control member 218 is in engagement with the first valve seat 222 to provide a relatively low fluid flow rate through the passageway 204.

In particular, the first valve trim apparatus 210 provides a pathway 236 that fluidly couples a first portion 204a of the passageway 204 in fluid communication with the inlet 206 and a second portion 204b of the passageway 204 in fluid communication with the outlet 208 when the first flow control member 218 is engaged with the first valve seat 222 and the second flow control member 224 moves relative to the second valve seat 234. More specifically, the pathway 236 extends between the opening 232 adjacent the sealing surface 230 of the first flow control member 218 and an opening 238 adjacent a surface 240 (e.g., a lateral surface) of the first valve stem 220. Thus, the opening 232 of the first flow control member 218 and the openings 220a and 238 of the first valve stem 220 define the pathway 236. In other examples, the opening 238 may be provided adjacent a lateral surface of the first flow control member 218. In the illustrated example, an axis 242 of a first portion 236a of the pathway 236 (e.g., the opening 232 adjacent the sealing surface 230) is non-parallel (e.g., is perpendicular) relative to an axis 244 of a second portion 236b of the pathway 236 (e.g., the opening 238 adjacent the surface 240). However, in other examples, the opening 232 of the first flow control member 218 and/or the opening 238 of the first valve stem 220 may include a plurality of openings (e.g., multiple smaller openings).

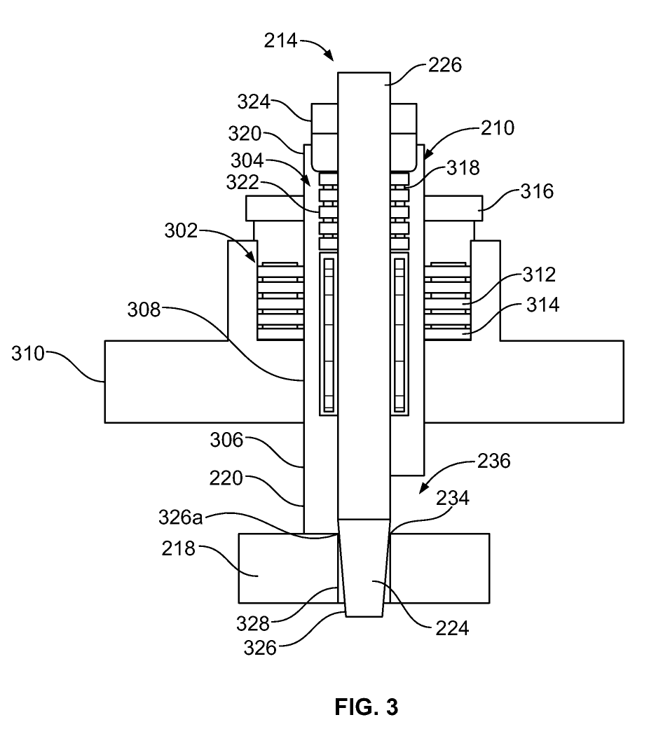

FIG. 3 illustrates a cross-sectional view of the example valve trim apparatus 210 and 214 of FIG. 2. The first valve trim apparatus 210 of the illustrated example also includes a first seal or packing system 302 to seal and prevent fluid leakage to the environment via the first valve stem 220. Similarly, the second valve trim apparatus 214 of the illustrated example includes a second seal or packing system 304 to prevent fluid leakage to the environment via the second valve stem 226.

As shown in FIG. 3, the first valve stem 220 has an outer surface 306 that slidably engages an opening 308 of a bonnet 310 of the fluid valve 200. The first packing system 302 (e.g., a live-loaded packing) includes packing or seals 312 (e.g., graphite rings, PTFE rings, etc.) that are disposed in a cavity 314 (e.g., a bore) of the bonnet 310 adjacent the opening 308 to prevent or restrict fluid leakage along the first valve stem 220 and to the environment via the opening 308 of the bonnet 310. A packing retainer or follower 316 retains the packing 312 within the cavity 314.

The first valve stem 220 also includes a cavity 318 adjacent an end 320 to receive the second packing system 304. The second packing system 304 (e.g., a live-loaded packing) includes packing or seals 322 (e.g., graphite rings, PTFE rings, etc.) that are disposed within the cavity 318 of the first valve stem 220 to prevent fluid leakage along the second valve stem 226 and to the environment via the opening 220a of the first valve stem 220. A packing retainer or follower 324 retains the packing 322 within the cavity 318.

As shown, the second flow control member 224 includes a tapered end 326 having a sealing surface 326a that engages the second valve seat 234 (e.g., an inner surface 328 of the opening 232) to restrict or prevent fluid flow through the pathway 236. The tapered end 326 of the second flow control member 224 may be composed of rubber. In other examples, the second flow control member 224 may be composed of a metallic material (e.g., stainless steel) that includes a seal (e.g., an O-ring) to sealing engage the second valve seat 234. In yet other examples, the second valve seat 234 may be a seat ring (e.g., composed of rubber) that is removably coupled to the first flow control member 218.

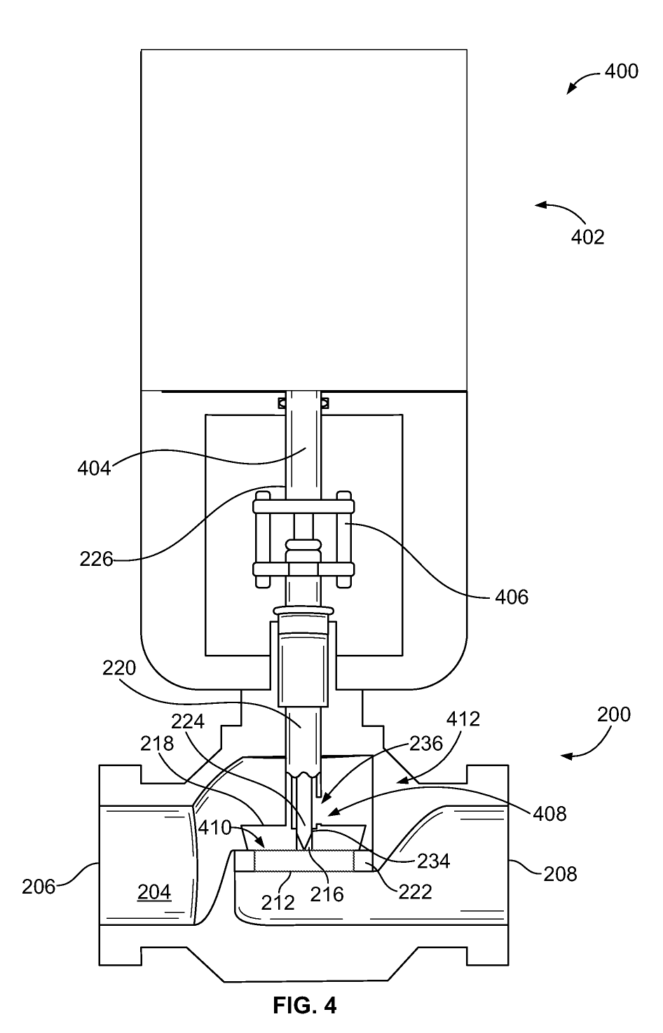

FIG. 4 depicts an example fluid control valve 400 described herein. Those components of the example fluid control valve 400 that are substantially similar or identical to the components of the fluid valve 200 described above and that have functions substantially similar or identical to the functions of those components will not be described in detail again below. Instead, the interested reader is referred to the above corresponding descriptions.

The fluid control valve 400 includes an actuator 402 (e.g., a pneumatic actuator, a hydraulic actuator, etc.) coupled to the fluid valve 200. In the illustrated example, the actuator 402 moves the first and second flow control members 218 and 224 relative to the respective valve seats 222 and 234 independently of each other.

The actuator 402 includes an actuator stem 404 to operatively couple the first valve stem 220 and a first pressure sensor (not shown) of the actuator 402. The actuator stem 404 is coupled to the first valve stem 220 via a connector 406. Additionally, the actuator stem 404 and/or the first pressure sensor each include an aperture or opening to slidably receive the second valve stem 226, which is coupled to a second pressure sensor (not shown) of the actuator 402. Thus, the first pressure sensor moves the first flow control member 218 relative to the first valve seat 222 via the first valve stem 220, the actuator stem 404 and the connector 406. Similarly, the second pressure sensor moves the second flow control member 224 relative to the second valve seat 234 via the second valve stem 226 that slidably moves relative to or through the first pressure sensor, the actuator stem 404, the first valve stem 220 and the first flow control member 218.

As shown in FIG. 4, the control valve 400 is in a closed position 408 to prevent fluid flow through the passageway 204. In other words, both of the flow control members 218 and 224 are in respective closed positions 410 and 412.

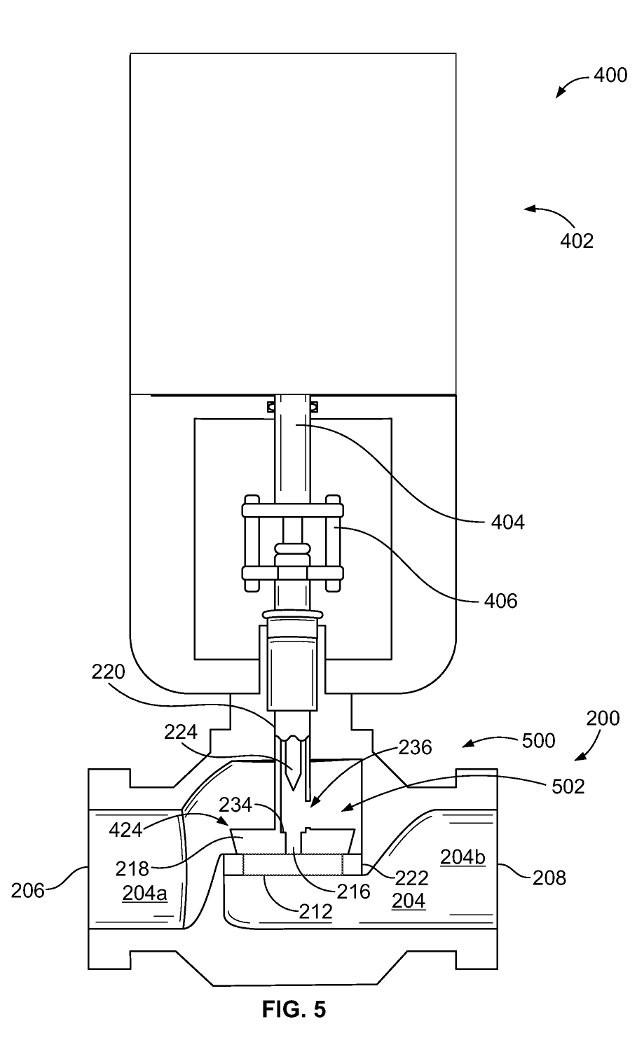

FIG. 5 illustrates the example fluid control valve 400 of FIG. 4 in an intermediate position 500. For example, in the intermediate position 500, the second flow control member 224 is positioned away from the second valve seat 234 to an open position 502 to allow fluid flow through the second orifice 216 or the pathway 236 and the first flow control member 218 is positioned in the closed position 410 to prevent or restrict fluid flow through the first orifice 212.

When the first flow control member 218 is in the closed position 410 and the second flow control member 224 is in the open position 502, fluid flows between the first and second portions 204a and 204b of the passageway 204 via the pathway 236. The second orifice 216 provides a reduced or low fluid flow area relative to the fluid flow area provided by the first orifice 212. In other words, the second flow control member 224 moves relative to the first flow control member 218 when the first flow control member 218 is in engagement (e.g., sealingly engaged) with the first orifice 212 to reduce the effective flow area of the passageway 204 provided by the first orifice 212 when the first flow control member is away from the first valve seat 222. As noted above, such a reduced flow area provided by the second orifice 216 enables the fluid valve 200 to provide precise, low flow control through the passageway 204 without compromising the fluid flow capacity provided by the first orifice 212.

Additionally or alternatively, the second flow control member 224 may be positioned to move away from the second orifice 216 to provide a pressure balance across the first flow control member 218 prior to moving the first flow control member 218 to an open position (i.e., a pressure-balanced flow control member 218). In this manner, the second flow control member 224 can move to the open position 502 to reduce a pressure differential across the first flow control member 218 and, thus, reduce breakout force to facilitate movement of the first flow control member 218 away from the first valve seat 222 and/or prevent damage to the first valve seat 222. Unlike conventional fluid valves such as the fluid valve 100 of FIG. 1, which may be susceptible to relatively high breakout force that may cause damage to a valve seat when the flow control member is moved to an open position, the example valve trim apparatus 210 and 214 of the illustrated example reduce breakout force by enabling the pressure across the first fluid control member 218 to lessen and/or equalize via the pathway 236. Further, in some examples, independently controlling the flow control members 218 and 224 facilitates tuning a controller (not shown) of the control valve 400 (e.g., a PID or proportional-integral-derivative controller).

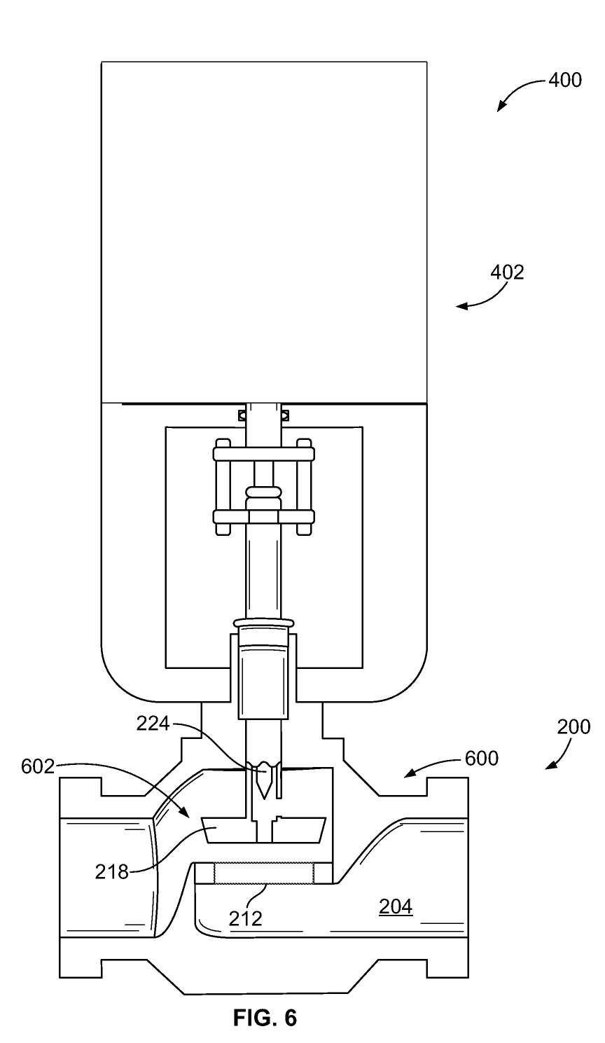

FIG. 6 illustrates the example fluid control valve 400 of FIG. 4 in an open position 600. For example, in the open position 600, the first flow control member 218 is also in an open position 602 to allow fluid flow through the passageway 204. In the open position 600, the fluid valve 200 enables relatively greater fluid flow through the first orifice 212 than, for example, the fluid flow through the second orifice 216 when the control valve 400 is in the intermediate position 500 of FIG. 5.

The actuator 402 may be configured to provide a staged operation or stroke-length. For example, the second flow control member 224 may move independently relative to the first flow control member 218 over a first partial stroke-length of the actuator 402 and/or the first pressure sensor and the second flow control member 224 may move dependently relative to the first flow control member 218 over a second partial stroke-length of the actuator 402 and/or the second pressure sensor.

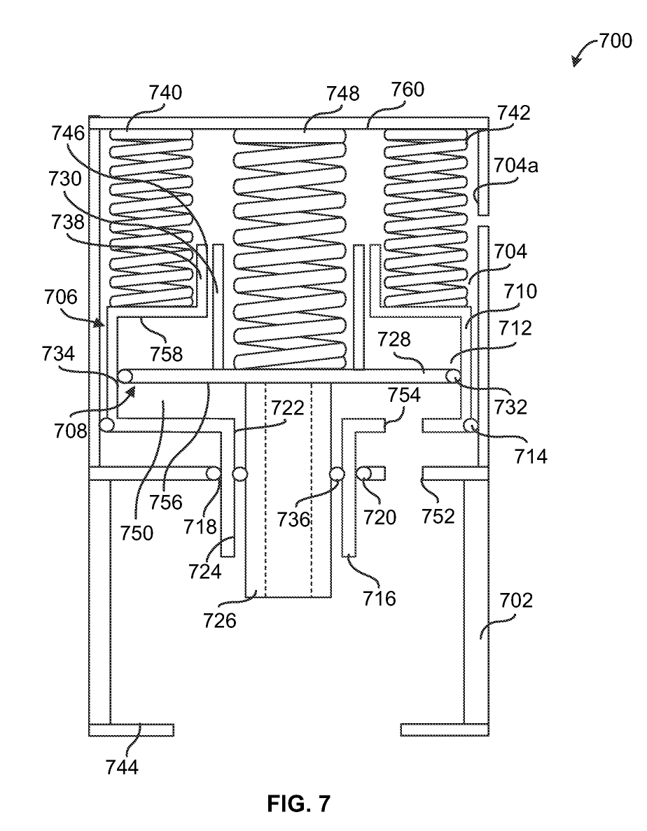

FIG. 7 depicts an example actuator 700 that may be used with the example fluid valve 200 of FIGS. 2-6. When coupled to the fluid valve 200 of FIGS. 2-6, the example actuator 700 may be used to move the first and second flow control members 218 and 224 in staged operation relative to the respective orifices 212 and 216 to control fluid flow therethrough.

The actuator 700 includes a body 702 defining a chamber 704 in which a first piston assembly 706 and a second piston assembly 708 are positioned. The first piston assembly 706 includes a first pressure sensor or piston 710 defining a piston chamber 712 in which the second piston assembly 708 is at least partially positioned. A seal 714 (e.g., an O-ring) may surround the first piston 710 to enable sliding and/or sealing engagement with an inner surface 704a of the chamber 704. The first piston assembly 706 may additionally include a first actuator stem 716 that extends through an aperture 718 defined by the actuator body 702. In this example, the first actuator stem 716 is integrally formed with the first piston 710. A seal 720 (e.g., an O-ring) may be positioned in the aperture 718 to sealingly and/or slidably engage the first actuator stem 716. The first piston 710 and the first actuator stem 716 may define respective apertures 722 and 724 to enable a second actuator stem 726 of the second piston assembly 708 to extend therethrough.

The second piston assembly 708 may include a second pressure sensor or piston 728 positioned between a spring seat 730 and the second actuator stem 726. The second piston 728 includes a seal or O-ring 732 to enable sliding and/or sealing engagement with an inner surface 734 of the piston chamber 712. A seal 736 may be positioned between the first and second actuator stems 716 and 726 to enable sliding and/or sealing engagement therebetween.

In particular, the first piston 710 is operatively coupled to the first flow control member 218 via, for example, the first actuator stem 716 and the connector 406 of FIGS. 4-6, and the second piston 728 is operatively coupled to the second flow control member 224 via the second actuator stem 726 and the second valve stem 226. Although not shown, the second actuator stem 726 may be coupled to the second valve stem 226 via a connector, a fastener, or any other suitable fastening mechanism(s). Thus, the first actuator stem 716 slides relative to the second actuator stem 726 when the first valve stem 220 of the first flow control member 218 slides relative to the second valve stem 226 of the second flow control member 224. For example, when the first and second pistons 710 and 728 are in their respective first or fail safe positions, the first flow control member 218 is in sealing engagement with the first valve seat 222 and the second flow control member 224 is in sealing engagement with the second valve seat 234. In other words, the first and second flow control members 218 and 224 are in their respective closed positions 410 and 412 of FIG. 4 when the first and second pistons 710 and 728 are in their respective first, neutral or fail-safe positions.

The first piston 710 may include an extension and/or spring seat 738 adjacent biasing elements or springs 740 and 742 that urge the first piston assembly 706 and/or the second piston assembly 708 toward a first or fail-safe position (e.g., toward a surface 744 of the actuator body 702). The first piston 710 may define an aperture 746 to enable the extension and/or spring seat 730 of the second piston assembly 708 to extend therethrough. A biasing element or spring 748 may be positioned adjacent to and/or within the spring seat 730 to urge the second piston assembly 708 and/or the first piston assembly 706 toward the first or fail-safe position (e.g., toward the surface 744).

In operation, staged movement of the pistons 710 and 728 is controlled by the springs 740, 742 and/or 748 and a control fluid provided within a control chamber 750 of the piston chamber 712. More specifically, the control fluid is provided (and exhausted) via the ports 752 and 754 defined by the actuator body 702 and the first piston 710, respectively, and provides a force on a surface 756 of the second piston 728.

In a first stage of operation and/or stroke length of the actuator 700, the first piston assembly 706 may be positioned in the first position and the second piston assembly 708 may be independently moveable relative to the first piston assembly 706 based on a pressure or force differential across the second piston 728 provided by the control fluid within the control chamber 750 and the spring 748. For example, during the first stage of operation, the actuator 700 moves the fluid valve 200 to the intermediate position 500 of FIG. 5. In other words, the second piston assembly 708 moves the second flow control member 224 to the open position 502 of FIG. 5 and the first piston assembly 706 moves the first flow control member 218 in the closed position 410.

In a second stage of operation and/or stroke length of the actuator 700, the second piston 728 engages a surface 758 of the first piston 710 and moves/drives the first piston assembly 706 from the first position toward a surface 760 of the actuator body 702 to compress the springs 740, 742 and 748. The first piston 710 moves toward the surface 760 based on a pressure or force differential across the first piston 710 provided by the control fluid within the control chamber 750 and the second piston 728 acting on the surface 758 of the first piston 710 and the spring forces of the springs 740, 742 and 748 acting against the respective pistons 710 and 728. For example, during the second stage of operation, the actuator 700 moves the fluid valve 200 to the open position 600 of FIG. 6. In other words, the first piston 710 moves toward the surface 760 to move the first flow control member 218 to the open position 602 of FIG. 6, when the second piston assembly 708 moves the first piston assembly 706 toward the surface 760.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A valve trim assembly for use with a fluid valve comprising:
a first flow control member having a sealing surface to move relative to a first valve seat of a passageway of the fluid valve, the first valve seat defining a first orifice that is to provide a first fluid flow area of the passageway when the first flow control member moves relative to the first valve seat, wherein the first flow control member has an opening adjacent the sealing surface to define a second orifice of the passageway when the first flow control member is in engagement with the first valve seat; and
a second flow control member slidably coupled relative to the first fluid flow member, the second flow control member is to move relative to the opening of the first flow control member when the first flow control member is in engagement with the first valve seat to provide a second fluid flow area of the passageway.

2. A valve trim assembly as defined in claim 1, wherein the first flow area provided by the first orifice is greater than the second flow area provided by the second orifice.

3. A valve trim assembly as defined in claim 2, wherein the second flow control member moves relative to the second orifice when the first flow control member is in engagement with the first orifice to reduce the effective flow area of the passageway provided by the first orifice.

4. A valve trim assembly as defined in claim 1, wherein the first flow control member further comprises a pathway that fluidly couples a first portion of the passageway in fluid communication with an inlet of the passageway and a second portion of the passageway in fluid communication with an outlet of the passageway when the first flow control member is engaged with the first valve seat and the second flow control member moves relative to the second seat.

5. A valve trim assembly as defined in claim 4, wherein the opening defines at least a portion of the pathway.

6. A valve trim assembly as defined in claim 5, wherein the pathway of the first flow control member extends between the seating surface of the first flow control member and a lateral surface of the first flow control member.

7. A valve trim assembly as defined in claim 6, wherein an axis of a first portion of the pathway adjacent the seating surface is non-parallel relative to an axis of a second portion of the pathway adjacent the lateral surface.

8. A valve trim assembly as defined in claim 1, wherein the first flow control member includes a first valve stem to slidably receive the second flow control member.

9. A valve trim assembly as defined in claim 8, wherein the first valve stem comprises a sleeve having an aperture to slidably receive the second flow control member.

10. A valve trim assembly as defined in 9, wherein second flow control member includes a second valve stem slidably disposed in the first valve stem.

11. A valve trim assembly as defined in claim 10, wherein the first valve stem includes a recessed bore coaxially aligned with the aperture to receive a first seal or packing system to provide a seal to an outer surface of the second valve stem.

12. A valve trim assembly as defined in 11, further comprising a second seal or packing system disposed within an opening of a valve body to provide a seal to an outer surface of the first valve stem.

13. A valve trim assembly as defined in claim 1, wherein the second flow control member includes a bore coaxially aligned with an axis of the second valve stem to define the first orifice of the passageway, wherein the first flow control member moves relative to the first valve seat to control fluid flow through the pathway when the second flow control member is in sealing engagement with a second valve seat of the passageway.

14. A valve trim apparatus as defined in claim 1, wherein the first flow control member moves independent from the second flow control member.

15. A fluid valve, comprising:
a valve body defining a passageway between an inlet and an outlet;
a first flow control member disposed in the passageway, the first flow control member is to move relative to a first orifice of the passageway to provide a first fluid flow characteristic through the passageway; and
a second flow control member disposed within the passageway, the second flow control member is to move relative to a second orifice of the passageway defined by the first flow control member when the first flow control member is in sealing engagement with the first orifice to provide a second fluid flow characteristic through the passageway, the first fluid flow characteristic being different than the second fluid flow characteristic.

16. A fluid valve as defined in claim 15, wherein the first flow control member is slidably coupled to the second flow control member.

17. A fluid valve as defined in claim 15, wherein the first flow control member is movable relative to the first orifice of the passageway via a first valve stem and the second flow control member is movable relative to the second orifice of the first flow control member via a second valve stem.

18. A fluid valve as defined in claim 17, further comprising an actuator, wherein the first flow control member is operatively coupled to a first actuator component via the first valve stem and the second flow control member is operatively coupled to a second actuator component via the second valve stem.

19. A fluid valve as defined in claim 15, wherein the second orifice reduces the effective flow area of the passageway when the first flow control member is engaged with the first valve seat and the second flow control member moves relative to the second orifice.

20. A valve trim assembly for use with a fluid valve comprising:
first means for controlling fluid flow through a first means for providing a first flow characteristic of a passageway of a valve body, the first means for controlling fluid flow defining a second means for providing a second flow characteristic of the passageway when the first means for controlling is in a closed position, wherein the first flow characteristic is different than the second flow characteristic; and
second means for controlling fluid flow through the second means for providing the second flow characteristic of the passageway, wherein the second means for controlling fluid flow is slidably coupled to the first means for controlling fluid flow.
